(19) United States
(12) Patent Application Publication
(10) Pub. No.: US 2026/0332220 A1
(43) Pub. Date: Oct. 22, 2026

(54) SIGNALING COMPLETE EXTENDED SERVICE SET CHANNEL INFORMATION TO STATIONS

(71) Applicant: Cisco Technology, Inc., San Jose, CA (US)

(72) Inventors: Binita Gupta, San Diego, CA (US); Brian D. Hart, Sunnyvale, CA (US)

(21) Appl. No.: 19/652,141

(22) Filed: Apr. 20, 2026

Related U.S. Application Data
(60) Provisional application No. 63/791,113, filed on Apr. 18, 2025.
(60) Provisional application No. 64/019,053, filed on Mar. 27, 2026.

(51) Int. Cl. H04B 7/06; H04L 43/062

(52) U.S. Cl. CPC H04B 7/0626; H04L 43/062

(57) ABSTRACT

Signaling complete Extended Service Set (ESS) information to Stations (STAs) may be provided. An access point (AP) operates as a member of an extended service set (ESS), the ESS comprising a plurality of APs sharing a common service set identifier (SSID) and connected to a common distribution system. The AP transmits a management frame to a client device, the management frame comprising an indicator set to indicate that complete ESS channel information is provided, and one or more elements comprising the complete ESS channel information, wherein the complete ESS channel information comprises primary channel information for the plurality of APs of the ESS.

### RELATED APPLICATIONS

Under provisions of 35 U.S.C. § 119(e), Applicant claims the benefit of and priority to U.S. Provisional Application No. 63/791,113, filed Apr. 18, 2025, and U.S. Provisional Application No. 64/019,053, filed Mar. 27, 2026, the disclosures of which are incorporated herein by reference in their entirety.

### TECHNICAL FIELD

The present disclosure relates generally to signaling complete Extended Service Set channel information to Stations.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for signaling complete Extended Service Set (ESS) channel information in accordance with aspects of the present disclosure.

FIG. 2 is a block diagram of the operating environment with a Seamless Mobility Domain (SMD) in accordance with aspects of the present disclosure.

FIG. 3A illustrates an example neighbor report element in accordance with aspects of the present disclosure.

FIG. 3B illustrates an example frame carrying a complete ESS channel information provided indicator in accordance with aspects of the present disclosure.

FIG. 4 illustrates an example reduced neighbor report element in accordance with aspects of the present disclosure.

FIG. 5 is a flow diagram illustrating a method for signaling complete ESS channel information in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### Overview

Signaling complete Extended Service Set (ESS) information to Stations (STAs) may be provided. An access point (AP) operates as a member of an extended service set (ESS), the ESS comprising a plurality of APs sharing a common service set identifier (SSID) and connected to a common distribution system. The AP transmits a management frame to a client device, the management frame comprising an indicator set to indicate that complete ESS channel information is provided, and one or more elements comprising the complete ESS channel information, wherein the complete ESS channel information comprises primary channel information for the plurality of APs of the ESS.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In wireless local area network (WLAN) systems, an extended service set (ESS) refers to a network configuration in which access points (APs) are communicatively coupled via a distribution system, such as a wired local area network, and collectively provide wireless connectivity under a common service set identifier (SSID). Each AP defines a respective basic service set (BSS), and the aggregation of such BSSs forms the ESS.

The ESS enables wireless client devices (e.g., a Station (STA), a non-AP Multi-Link Device (MLD)) to associate with any of the plurality of APs while appearing to operate within a single logical network. As a client device moves within the coverage area of the ESS, the client device may transition its association from one AP to another AP within the ESS. Such transitions may be managed according to conventional Institute of Electrical and Electronics Engineers (IEEE) 802.11 protocols and related enhancements. The ESS thereby extends network coverage beyond the range of a single AP while maintaining continuity of network access from the perspective of higher-layer protocols.

Roaming in Wi-Fi networks occurs when a client device transitions its connection from one Access Point (AP) or AP MLD to another, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

Roaming techniques have been developed to reduce roaming latency and improve user experience during AP transitions. Traditional roaming techniques include those described in IEEE 802.11k, which reduce the time required to roam by enabling a client device to more quickly determine which AP it should roam to next, with the serving AP providing information regarding neighboring APs and their channels. Another roaming technique is described in IEEE 802.11r, which uses Fast Basic Service Set (BSS) Transition (FT) to allow keys (e.g. PMK) to be established for the APs in a network in advance, enabling a client device to avoid performing the complete authentication process to a backend server every time it roams to a new AP within the network, thus reducing authentication-related latency during roaming.

SMD based seamless roaming (also referred to as SMD roaming or SMD BSS transition) as defined in the IEEE 802.11bn amendment introduces Seamless Mobility Domains (SMDs), which are logical, secure groupings of multiple AP MLDs that enable client devices to roam between them without disconnecting, re-authenticating, re-associating, or experiencing packet loss (or minimal packet loss). SMD roaming enables a “make-before-break” approach where a device establishes a connection to a new AP MLD before releasing the old one by utilizing multiple links. This allows the client device to maintain connectivity during the transition and reduces data loss, as the client device can communicate with both the serving AP MLD and the target AP MLD over different links during the transition. An ESS can form or facilitate an SMD. An SMD may correspond to an entire ESS or a subset thereof, depending on configuration and capability. For example, an ESS can include one or more FT mobility domains, and each FT mobility domain can include one or more SMDs.

The IEEE 802.11bn seamless roaming procedures include a roaming preparation phase during which the client device and serving AP exchange signaling to prepare one or more target APs for the upcoming roaming transition, followed by a roaming execution (or roaming transition) phase during which the actual transition to the target AP occurs. The roaming preparation phase may include negotiation of target APs, establishment of security associations with target APs, link setup, context transfer, and Quality of Service (QoS) related resource reservation on the target AP MLD, enabling the subsequent roaming execution to occur with minimal latency and data loss. Once a client device has performed roaming preparation with a target AP MLD, it can then perform roaming execution to that target AP MLD to roam to that target AP. The roaming execution involves dynamic context transfer and changing the distribution system (DS) mapping for the client device from the current AP MLD to the target AP MLD.

In 802.11 networks, baseline information about other APs in the network can be provided using existing mechanisms of Reduced Neighbor Report (RNR) elements or Neighbor Report (NR) elements. RNR elements can be provided as part of beacon and probe response frames, and NR elements can be provided as part of Neighbor Report Response and BSS Transition Management (BTM) Request frames. However, the NR and RNR elements do not currently indicate complete ESS channel information.

There are some deployments where the set of APs or AP MLDs in an ESS is small (e.g., one AP device or a few AP devices), such as in a small business (e.g., restaurants, cafes) or home deployments. In such cases, if a STA is made aware of all the channels on which these APs are operating, the STA can limit its scanning to only those channels, thus improving its scanning operation, reducing power consumption, and improving roaming performance. A STA can determine primary channel information for neighboring APs based on RNR and NR elements, but the STA has no indication of whether these elements provide information for all possible APs in the ESS. As a result, even after learning of some AP channels via RNR or NR, a STA implementation may continue scanning other channels under the assumption that additional APs, not reflected in the received elements, may be operating elsewhere in the same ESS. Accordingly, signaling that expressly indicates to a STA that the channel information for the complete set of APs in the ESS (or in the current SMD) is described herein, enabling the STA to confine its scanning and roaming efforts to the identified channels.

The present disclosure describes techniques for signaling to a STA complete ESS channel information, which identifies primary channel information all APs or AP MLDs operating in the ESS (or in the current SMD). Additionally, mechanisms for delivering the complete ESS channel information at association and for updating it post-association is described. An indicator signals to an associated STA that the AP or AP MLD is providing primary channel information for all APs or AP MLDs in the ESS. The indicator (e.g., a ‘Complete ESS Channel Information Provided’ field or bit) can be provided as part of an Ultra High Reliability (UHR) element, such as a UHR Capabilities element, a UHR Operation element, or a UHR Operation Parameters element. The indicator can also be provided in a Basic Multi-Link (ML) element e.g. using one of the reserved bits. Additionally, the indicator can be provided in the beacon, probe response, (re)association response, BTM Request, Neighbor Report Response, Link Reconfiguration Response and other frames. Upon receiving this indication, the STA may limit its scanning to only those channels, thereby reducing scan latency, conserving power, and improving roaming performance. Because the set of APs in an ESS and the primary channels they use may change after association (e.g., when an AP is added, removed, or reconfigured to a different channel) the present disclosure further describes mechanisms for delivering updated complete ESS channel information to associated STAs.

A non-AP STA or non-AP MLD that receives a frame with indication that complete ESS channel information is provided uses the accompanying RNR, NR, or AP Channel Report elements to determine the complete set of primary channels for all APs in the ESS (or SMD) and limits its scanning and roaming activity to those channels. If no neighboring APs or channel information is identified in the associated elements, the STA or non-AP MLD determines that the serving AP is the only AP in the ESS (or SMD). If the frame indicates that complete ESS channel information is not provided, the STA or non-AP MLD treats any provided RNR or NR elements as a partial listing of APs’ channels in the ESS instead of a complete listing of APs’ channels.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

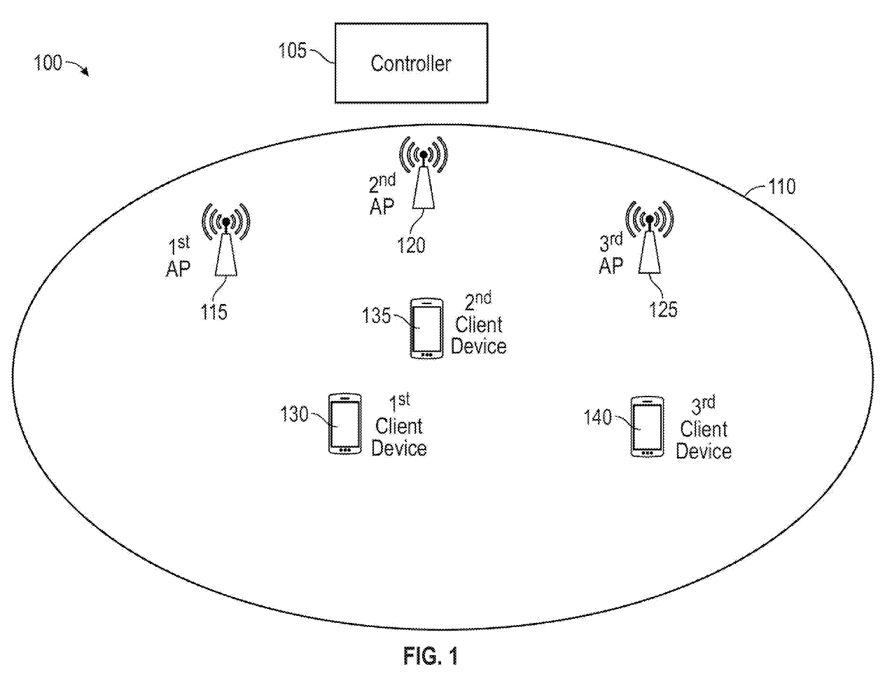

FIG. 1 illustrates an operating environment 100 for signaling complete Extended Service Set (ESS) channel information to STAs. As shown in FIG. 1, the operating environment 100 includes a controller 105 and a coverage environment 110. The coverage environment 110 may comprise, but is not limited to, a WLAN comprising a plurality of APs that may provide wireless network access (e.g., access to the WLAN for client devices). The plurality of APs includes a first AP 115, a second AP 120, and a third AP 125. As described below, the plurality of APs may comprise any number of APs and is not limited to three. Any number of the plurality of APs can form one or more ESSs. Accordingly, the APs can be communicatively coupled via a distribution system, such as a wired local area network, and collectively provide wireless connectivity under a common SSID. The APs can also form one or more SMDs.

The plurality of APs may provide wireless network access to a plurality of client devices (i.e., STAs) as they move within coverage environment 110. An AP is generally a fixed station that communicates with client devices and may also be referred to as a base station, wireless device, or other terminology. The plurality of client devices may comprise, but are not limited to, a first client device 130, a second client device 135, and a third client device 140. The plurality of client devices may comprise non-AP MLDs. The plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the IEEE 802.11 specification standard.

The plurality of APs and the plurality of client devices may use Multi-Link Operation (MLO), where they simultaneously transmit and receive across different bands (or links) and channels by establishing two or more links to two or more AP radios. Accordingly, the plurality of APs and the plurality of client devices may comprise MLDs. These bands may comprise, but are not limited to, the 2.4 GHz band, the 5 GHz band, the 6 GHz band, and the 60 GHz band. The two or more links on any given one of the plurality of client devices may be made with any one AP or with any combination of the APs.

The controller 105 may comprise a WLAN controller (WLC) and may provision and control coverage environment 110 (e.g., a WLAN). Controller 105 may allow first client device 130, second client device 135, and third client device 140 to join coverage environment 110. In some embodiments, controller 105 may be implemented by a Digital Network Architecture Center (DNAC) controller (i.e., a Software-Defined Network (SDN) controller) that may configure information for coverage environment 110 to facilitate signaling of complete ESS channel information to STAs. The APs and/or controller 105 can interface with the distribution system to form and manage ESSs and SMDs.

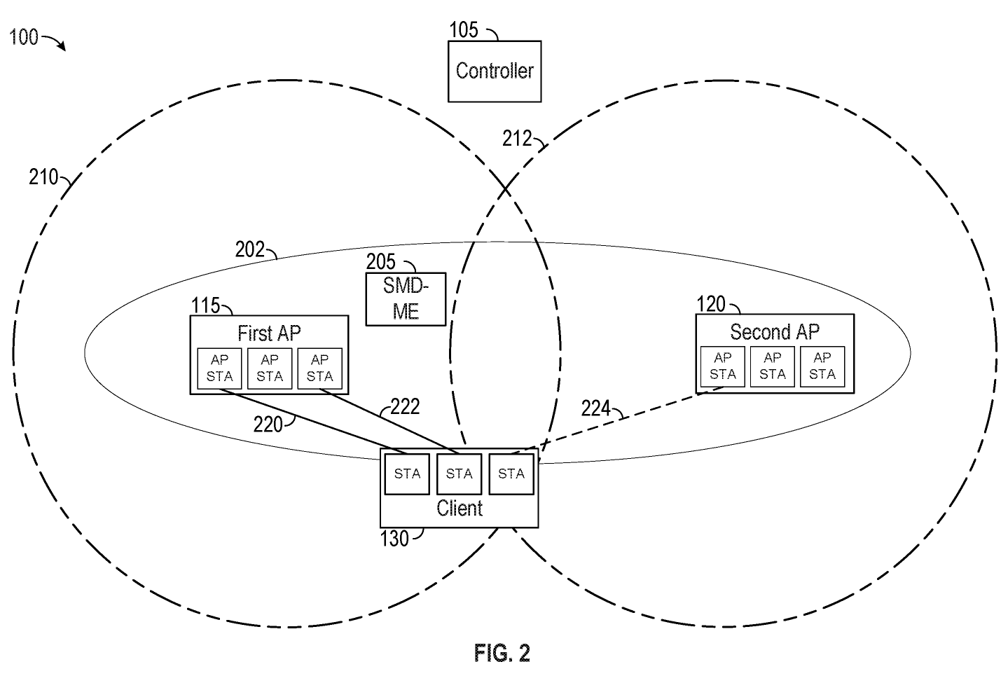

FIG. 2 is a block diagram of operating environment 100 including an SMD. In the illustrated embodiment, operating environment 100 includes the first AP 115, the second AP 120, the client device 130, and the controller 105. The first AP 115 has a service area or cell indicated by the first cell 210, and the second AP 120 has a service area indicated by the second cell 212. The range of the first AP 115 and the second AP 120 may extend past the boundaries of the associated cells, resulting in overlapping coverage, but signals grow weaker as devices move away from the respective APs. The edges of the first cell 210 and the second cell 212 as shown in operating environment 100 are examples and may differ in other implementations (e.g., different sizes, shapes, etc.).

The APs in operating environment 100 can be grouped into one or more SMDs, such as SMD 202 in the illustrated embodiment. SMD 202 provides seamless roaming to clients across AP MLDs within SMD 202. Client device 130 associates at the SMD level with an SMD-Management Entity (SMD-ME) 205 within SMD 202 and then roams between AP MLDs within SMD 202 without performing reauthentication or reassociation, achieving seamless roaming. The SMD-ME 205 is a logical entity present in the APs of SMD 202 and the associated client devices (e.g., present in the MLD Upper Media Access Control (MAC) of the APs and client devices) in certain embodiments. The first AP 115 and second AP 120 are part of the same SMD 202 in the illustrated embodiment. Each SMD may be uniquely identified within the network by an SMD Identifier, which may be a 48-bit MAC address, enabling SMDs to be uniquely distinguished independent of whether they are part of the same SSID or different SSIDs.

As illustrated in FIG. 2, client device 130 is currently associated with SMD 202 (e.g., via SMD-ME 205), within the first cell 210, and connected with the first AP 115. However, client device 130 may be moving toward the boundary of the first cell 210 and into the second cell 212, indicating that client device 130 may soon need to roam from the first AP 115 to the second AP 120 or another neighbor AP to maintain network connectivity and quality of service (QoS). To perform seamless roaming, client device 130 selects a candidate target AP that belongs to the same SMD as its serving AP.

The APs in SMD 202 support seamless roaming procedures (e.g., as defined in the IEEE 802.11bn amendment), including roaming preparation and roaming execution (or roaming transition) phases, which enable client devices such as first client device 130 to transition between APs (e.g., AP MLDs) within the same SMD 202 with reduced roaming latency and data loss. A single physical AP device may host multiple AP MLDs and multiple SSIDs.

Controller 105 may manage the first AP 115, the second AP 120, SMD 202, SMD-ME 205, and/or other network devices (not shown) to allow wireless devices such as first client device 130 to connect to the network. In some embodiments, the operations of controller 105 described herein may be performed by one or more of the APs, and/or another device, and vice versa. In some embodiments, controller 105 is included within or integrated with an AP and coordinates the links formed by that AP. In some embodiments, controller 105 is separate from the APs and coordinates the links of multiple APs. The operating environment 100 illustrated in FIGS. 1 and 2 is an example configuration, and there may be a different number of clients, APs, controllers, and/or other devices in further examples.

As used herein, an AP together with the client devices associated with that AP (e.g., the client devices within the AP’s coverage area or cell) is referred to as a BSS. In the illustrated example, the first AP 115 is the serving or current AP for the first client device 130 within the first cell 210. The APs may communicate with one or more client devices on the downlink (DL) and uplink (UL). The DL is the communication link from an AP to a client device, and the UL is the communication link from a client device to an AP. In some cases, a client device may also communicate peer-to-peer with another client device.

To enable a client device to identify candidate APs for roaming, APs transmit NR and/or RNR elements in beacon frames and probe responses. NR and RNR elements report information about neighboring APs, including APs that are collocated on the same physical AP device as the reporting AP (i.e., within the same collocated AP set) and, in certain configurations such as probe responses, non-collocated neighboring APs hosted on separate physical AP devices.

As shown in FIG. 2, client device 130 and the APs are MLDs and each include one or more STAs. Client device 130 uses its STAs to form links with the AP STAs. For example, client device 130 may use a first STA to form a first wireless link 220 with a corresponding STA of the first AP 115, and client device 130 may use a second STA to form a second wireless link 222 with another STA of the first AP 115. Each STA may include Physical (PHY)-layer and lower-MAC components. The MLDs may also include an upper-MAC for coordinating the multiple STAs (or links) that are part of the MLD. The STAs can use different frequency bands for various wireless links. For example, the first wireless link 220 may be formed using a 5 GHz band and the second wireless link 222 may be formed using a 6 GHz band. These are example frequency bands, and the wireless links may use any suitable frequency bands, including 2.4 GHz, 5 GHz, 6 GHz, or other bands.

In general, the AP(s) and client device 130 may form any suitable number of links for communication using any suitable frequencies. In some instances, first client device 130 may form links with one AP (e.g., the first wireless link 220 and the second wireless link 222 with the first AP 115). In other instances, first client device 130 may form links with multiple APs (e.g., the first wireless link 220 and the second wireless link 222 with the first AP 115 and a third wireless link 224 with the second AP 120). As a result, client devices may communicate with one or more APs over multiple links using different frequencies. Additionally, setup links may not always be active or otherwise useable. For example, the third wireless link 224 may be set up with the second AP 120 as part of roaming preparation, but roaming execution may not have occurred yet. After roaming execution to the second AP 120, the third wireless link 224 becomes useable for data communication.

Client device 130 may be referred to as a STA MLD or non-AP MLD (e.g., a STA or client device acting as an MLD), and the first AP 115 or second AP 120 may be referred to as an AP MLD (e.g., an AP that acts as an MLD). The STA MLD and AP MLD are generally representative of any device capable of performing ML operations. An MLD may generally be classified based on whether it is a single radio MLD or multi-radio MLD. Single radio MLDs generally use a single radio (e.g., STA) to switch between one or more links.

In certain embodiments, operating environment 100 enables client device 130 to utilize seamless roaming techniques such as roaming without performing re-association with one or more APs, receiving NR and RNR elements to determine a target AP, and so on. As client device 130 moves away from the coverage of an AP, client device 130 may perform roaming preparation procedures to add links with a target AP MLD as it enters the coverage of target APs within SMD 202 to continue connectivity with the network. In certain embodiments, beacon signal strength measurements (e.g., RSSIs) from APs in the roaming path of client device 130 act as triggers for initiating roaming preparation to add links with a target AP MLD.

The APs in operating environment 100, whether organized into an ESS alone or into both an ESS and an SMD, can signal complete ESS channel information to client devices. As used herein, “complete ESS channel information” refers to primary channel information for all APs or AP MLDs in the ESS, or in the current SMD. An AP or AP MLD signals to an associated STA that it is providing primary channel information for all APs or AP MLDs in the ESS using an ESS indicator (e.g., a “complete ESS channel information provided” indicator). In some embodiments, an SMD indicator (e.g., a “complete SMD channel information provided” indicator) may additionally or alternatively be used to indicate that channel information for all APs or AP MLDs in the current SMD is provided, which is particularly useful for ESS deployments in which the SMD encompasses only a portion of the ESS. Upon receiving the complete ESS channel information provided indicator and the primary channel information for all APs or AP MLDs in the ESS, a STA may confine its scanning and roaming activity to only the identified channels, thereby reducing scan latency, conserving power, and improving roaming performance. When the serving AP is the only AP in the ESS (e.g. in single AP deployments in a residence), the AP may assert the indicator without including any neighboring AP channel information, since no neighboring APs exist to report.

The complete ESS channel information may be carried in existing or new information elements and delivered in various management frames during and after association. Because the primary channel information for set of APs in an ESS may change over time (e.g., when an AP is added, removed, or reconfigured to a different channel), the APs can also deliver updated complete ESS channel information to associated STAs through multiple mechanisms. The specific elements, frames, and procedures used to signal and update complete ESS information are described in further detail below with respect to the following figures.

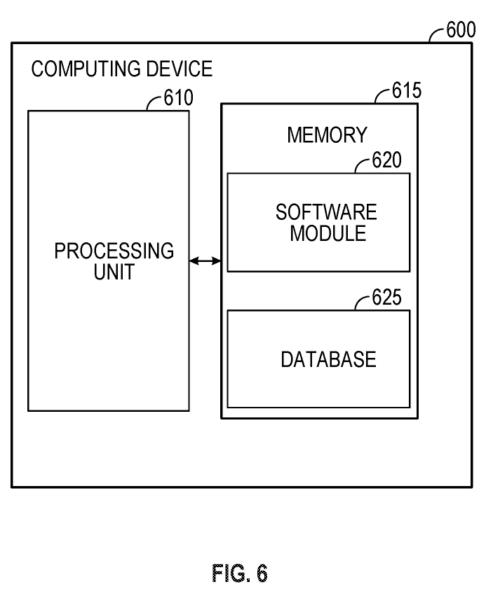

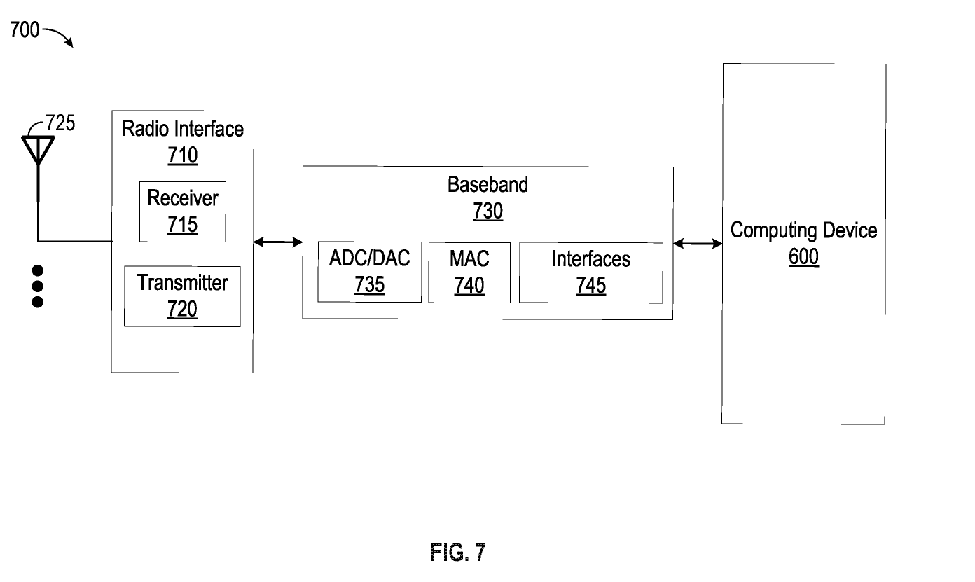

The elements described above of the operating environment 100 (e.g., the controller 105, the APs, the client devices, the SMD-ME 205, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

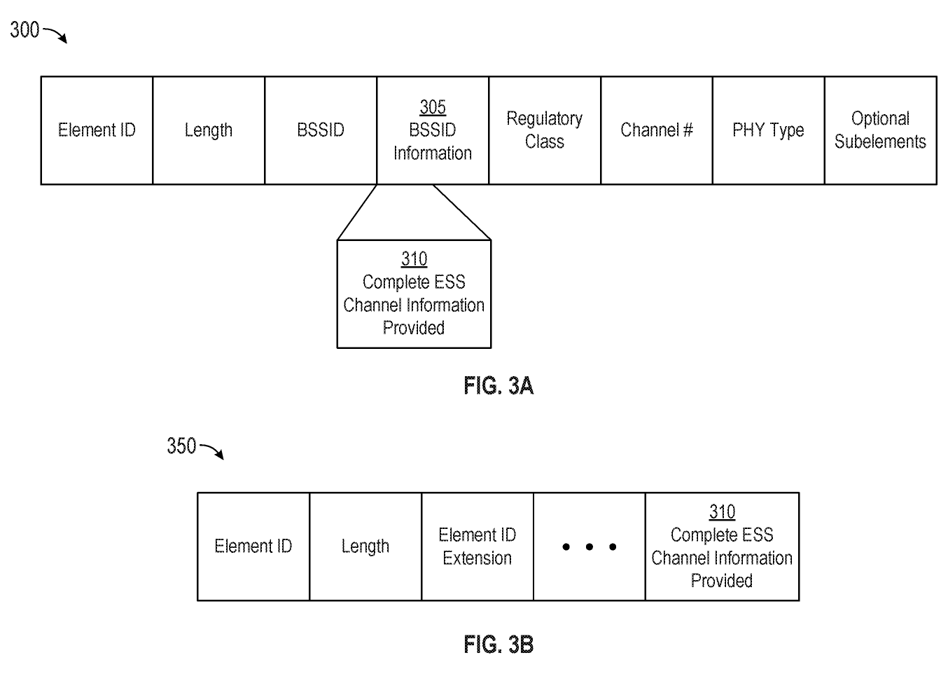

FIG. 3A illustrates an example NR frame 300. An NR element 300 can be included for each AP whose information is to be provided as part of complete ESS channel information. The illustrated NR element 300 includes, among other fields, a BSS Identifier (BSSID) Information field 305. The BSSID Information field 305 includes a Complete ESS Channel Information Provided field 310 (e.g., one bit in length) that indicates when complete ESS channel information is provided. In the illustrated embodiment, the Complete ESS Channel Information Provided field 310 is located within the BSSID Information field 305. In further embodiments, the Complete ESS Channel Information Provided field 310 may be in another field of the NR element 300, or in another element entirely, as described below.

When the Complete ESS Channel Information Provided field 310 is set to a first value (e.g., 1), the list of accompanying NR elements 300 collectively identifies all APs or AP MLDs in the ESS. Each NR element 300 reports operating channel information for the corresponding AP, enabling a receiving STA to determine the complete set of primary channels used by all APs in the ESS. The NR elements 300 conveying complete ESS channel information may be included in one or more management frames, including a BTM Request frame, a Neighbor Report Response frame, or a (Re)Association Response frame, as described in greater detail below.

In various embodiments, the Complete ESS Channel Information Provided field 310 or another indication may alternatively or additionally be conveyed using any one or more of the following approaches. In a first embodiment, a reserved bit in the Basic ML element signals complete ESS channel information provided by the AP MLD. For example, a reserved bit in the Presence Bitmap or in the MLD Capabilities and Operations subfield of the Basic ML element may be designated for this purpose. In a second embodiment, a bit in a UHR element that provides UHR parameters for the BSS is used. For example, a bit in a UHR Operation Parameters element containing static or semi-static parameters of the BSS, in a UHR Capabilities element, or in a UHR Operation element may indicate that complete ESS channel information is provided. In a third embodiment, a field or bit in an ESS Report element (either by extending the existing ESS Report element or by defining a new Extended ESS Report element) is used to report whether complete ESS channel information is provided. In a fourth embodiment, such a bit or field may be added in any other existing or new element. Any of these signaling approaches may be used in beacon frames, probe response frames (including ML probe response frames), (Re)Association Response frames, BTM Request frames, Neighbor Report Response frames, Link Reconfiguration Response frames, or other management frames.

FIG. 3B illustrates an example frame 350 carrying the Complete ESS Channel Information Provided field 310 (or another complete ESS channel information provided indicator). The frame 350 is a UHR Operation element or a UHR Capabilities element in example implementations.

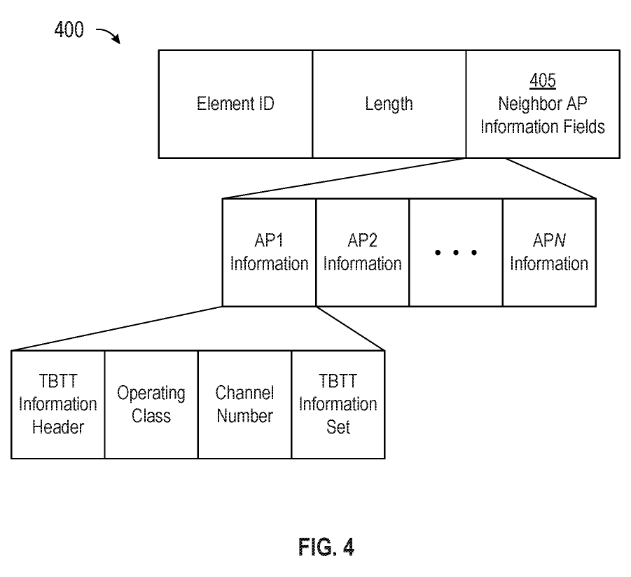

FIG. 4 illustrates an example RNR element 400. The RNR element 400 includes, among other fields, Neighbor AP Information Fields 405. When the Complete ESS Channel Information Provided field 310 or another indicator signaling that complete ESS channel information is provided (and is set to a first value (e.g., 1)), the Neighbor AP Information Fields 405 include respective fields for each AP necessary to communicate the complete ESS channel information. Each Neighbor AP Information Field 405 identifies a neighboring AP and its primary operating channel, such that the collective set of all Neighbor AP Information Fields 405 represents the complete set of primary channels used by all APs or AP MLDs in the ESS. A STA receiving the RNR element 400 with the complete ESS channel information provided indicator set is accordingly able to determine all channels on which ESS APs are operating without needing to scan additional channels.

The RNR element 400 may be included in beacon frames, probe response frames, BTM Request frames, and (Re)Association Response frames. In some implementations, RNR elements 400 may be used for indicating complete ESS channel information when deployments with a small number of APs in the ESS so including information for all APs within the RNR element 400 of a beacon may not cause significant beacon bloating. If the serving AP is the only AP in the ESS, then the beacon, probe response, or (Re)Association Response frame signals that complete ESS channel information is provided using one of the signaling approaches described above and does not include an RNR element 400 or any NR element 300 (because no neighboring AP information exists to convey).

### ReAssociation Response

In one embodiment, an AP includes an RNR element 400 in (Re)Association Response frames with information for all APs or AP MLDs in the ESS when the complete ESS channel information provided indicator is set or otherwise present. Under IEEE 802.11 baseline operation, the RNR element 400 is not included in (Re)Association Response frames. However, both the Association Response and Reassociation Response frames may be enhanced to include the RNR element 400 for indicating complete ESS channel information. When the complete ESS channel information provided indicator is set to a first value (e.g., 1), the RNR element 400 included in the (Re)Association Response frame carries Neighbor AP Information Fields 405 for all APs or AP MLDs in the ESS, providing the STA with the complete set of primary channels for the APs in the ESS at the time of association.

In another embodiment, information for all APs or AP MLDs in the ESS is provided via one or more NR elements 300 in (Re)Association Response frames. Under IEEE 802.11 baseline operation, NR elements 300 are included in (Re)Association Response frames only in the case of association failure. However, both the Association Response and Reassociation Response frames may be enhanced to include one or more NR elements 300 when (re)association is successful. This enhancement enables one or more NR elements 300 to provide information for all other APs that are part of the ESS when the complete ESS channel information provided indicator is set.

If the serving AP is the only AP in the ESS, the (Re)Association Response frame signals that complete ESS channel information is provided using one of the signaling approaches described above but does not include any RNR element 400 or NR element 300 (because no neighboring AP information exists to report). The STA receiving such a (Re)Association Response frame thereby determines that the serving AP is the only AP in the ESS.

### NR Element and Probe Response

As described above, the Complete ESS Channel Information Provided field 310 (e.g., a bit in the UHR Capabilities Element, a bit in the UHR Operation element, a reserved bit within the BSSID Information field 305 of the NR element 300) is used to indicate that complete ESS channel information is provided. When this field is set to a first value (e.g., 1), the accompanying list of NR elements 300 identifies all APs or AP MLDs in the ESS, with each NR element 300 providing the primary operating channel for the corresponding AP. This scheme may be used to provide complete ESS channel information in the BTM Request frame, the Neighbor Report Response frame, or the (Re)Association Response frame using NR elements 300.

In another embodiment, the Probe Response frame is enhanced to include one or more NR elements 300 that provide information for neighboring APs of the AP for which the Probe Response is sent. Under IEEE 802.11 baseline operation, Probe Response frames do not carry NR elements. However, a Probe Response frame is enabled to include one or more NR elements 300 to convey the complete set of APs or AP MLDs in the ESS. Therefore, a STA can acquire complete ESS channel information in a Probe Response frame without needing to first associate with an AP.

### Updates to Complete ESS Channel Information Post-Association

The complete set of primary channel information for APs or AP MLDs in an ESS may change over time. For example, when an AP is added to or removed from the ESS or when an AP is reconfigured to operate on a different primary channel. When a change occurs, the serving AP can provide updated complete ESS channel information to its associated STAs.

In one embodiment, an AP sends an unsolicited BTM Request frame, either broadcast to all associated STAs or individually addressed to specific STAs, to convey updated complete ESS channel information whenever that information changes. A Reason Code or another field in the BTM Request frame may indicate that the request is being sent to provide updated complete ESS channel information rather than to solicit a BSS transition. The updated complete set of channel information for APs or AP MLDs in the ESS is conveyed in the BTM Request frame using one or more NR elements 300 or an RNR element 400. If the ESS has changed such that the serving AP is the only remaining AP in the ESS (i.e., if all other APs have been removed), the BTM Request frame signals this by omitting any NR elements 300 from the BSS Transition Candidate List Entries and, when RNR was previously used for signaling, by omitting the RNR element 400.

The Reason Code or another field in such a BTM Request frame indicates that the request provides updated complete ESS channel information reflecting this reduction. In another embodiment, a dedicated bit in the BTM Request frame, rather than a Reason Code, indicates that the BTM Request is being sent to provide updated complete ESS channel information.

In another embodiment, an unsolicited NR Response frame is sent by the serving AP to push updated complete ESS channel information to associated STAs. The Complete ESS Channel Information Provided field 310 in the BSSID Information field 305 of the NR element 300 indicates that complete ESS channel information is provided, and the accompanying list of NR elements 300 identifies all APs or AP MLDs in the current ESS.

### Client Device Behavior

A client device (STA or non-AP MLD) that receives the complete ESS channel information provided indicator set to a first value (e.g., 1) uses the accompanying RNR element 400, NR elements 300, or another element (e.g. an AP Channel Report element) to determine the complete set of primary channels for all APs in the ESS and limits its scanning and roaming activity to only those channels. If the indicator is set to the first value but no RNR element 400 is provided and no neighboring APs are identified in any accompanying NR element 300 (or other elements), the client device determines that the serving AP is the only AP in the ESS and confines its scanning accordingly. If the complete ESS channel information provided indicator is set to a second value (e.g., 0), the client device treats the accompanying RNR element 400 or NR elements 300 (or other elements) as a partial listing of APs in the ESS rather than a complete one, and the client device may continue scanning other channels for additional APs.

In another embodiment, a separate indicator, referred to herein as a Complete SMD Information Provided indicator, may be used in addition to, or instead of, the Complete ESS Channel Information Provided indicator described above. The Complete SMD Information Provided indicator signals whether the complete set of APs or AP MLDs belonging to the same SMD as the serving AP MLD is provided in the accompanying RNR or NR elements. This indicator can be used for ESS deployments with non-contiguous coverage. For example, a campus spanning multiple buildings in which each building constitutes a separate SMD while all buildings share a common SSID. In such deployments, a client device may be more effectively served by information about the complete set of channels used by APs in its current SMD, rather than across the entire ESS, for purposes of optimizing scanning and roaming. The Complete SMD Information Provided indicator may be carried in the SMD element or may be conveyed using any of the signaling options described above with respect to the Complete ESS Channel Information Provided indicator.

In one embodiment, two separate bits are defined to independently indicate (a) complete ESS channel information provided and (b) complete SMD information provided. Based on the set of neighboring APs or AP MLDs for which information is provided in the accompanying RNR or NR elements (or other elements carrying complete ESS channel information), the appropriate bit or bits are set. For example, in an ESS that includes only one SMD, both bits are set when the complete set of APs in that SMD, which is also the entire ESS, is provided in the accompanying elements.

### Bounded ESS for Delivering Updated Complete ESS Channel Information

In embodiments compatible with IEEE 802.11bn, a Bounded ESS feature is defined for an AP MLD to indicate that it is providing primary channel information for all APs in the ESS. Specifically, if an AP MLD is able to provide a complete list of the primary channels used by all other AP MLDs in the ESS that are members of the same ESS and whose basic service areas (BSAs) overlap with the BSA of the AP MLD, if any, the AP MLD sets the Bounded ESS field in the UHR Capabilities elements it transmits to a first value (e.g., 1), and includes in the (Re)Association Response frames it transmits one or more AP Channel Report elements that give this list of channels. Otherwise, the AP MLD sets the Bounded ESS field to a second value (e.g., 0) and does not include any AP Channel Report elements in the (Re)Association Response frames. A non-AP STA receiving this information may use it to optimize its scans for other APs of the same ESS by scanning only those channels.

When the primary channels used by the APs of an ESS change after association, the serving AP or AP MLD provides the updated or latest set of primary channels used by all APs in the ESS to associated STAs or non-AP MLDs. In addition to the unsolicited BTM Request and Neighbor Report Response frame mechanisms described above, further embodiments for delivering updated complete ESS channel information are described below.

In one embodiment, a UHR Link Reconfiguration Notify frame, with a new Type value (or an existing Type value), is used to deliver updated primary channel information for all APs in the ESS to associated non-AP MLDs. The new Type value may be any currently unused Type value in the UHR Link Reconfiguration Notify frame format and indicates a notification to provide the latest primary channels used by all APs in the ESS. The UHR Link Reconfiguration Notify frame carrying this new Type value includes one or more AP Channel Report elements that provide the list of primary channels used by all APs in the ESS. This frame provides a targeted and efficient mechanism (aligned with link reconfiguration signaling already defined in IEEE 802.11bn) by which the serving AP MLD can push updated complete ESS channel information to associated non-AP MLDs without requiring a BSS transition procedure.

### AP Channel Report Element Placement and Per-STA Profile Rules

For embodiments using the Bounded ESS feature, (Re)Association Response frames carry one or more AP Channel Report elements to convey the complete list of primary channels for all APs in the ESS. Because complete ESS channel information is not specific to any individual link, AP Channel Report elements are not link-specific and therefore shall not be inherited or carried in the STA Profile field of a Per-STA Profile subelement included in a Basic ML element or another ML element that is included in any frame. This rule applies regardless of the frame type, including (Re)Association Response frames, Probe Response frames, Link Reconfiguration Response frames, Neighboring AP Probe Response frames, Link Reconfiguration Notify frames, and any other frame that carries a Basic ML element or another ML element such as a Reconfiguration ML element. Accordingly, the existing prohibition on including certain fields and elements in the STA Profile field of Per-STA Profile subelements, as defined for fields such as Timestamp, Beacon Interval, AID, BSS Max Idle Period element, and others, is extended to additionally exclude AP Channel Report elements. Thus, the AP Channel Report element cannot be carried in the STA Profile field of a Per-STA Profile subelement in a ML element such as a Basic ML element or a Reconfiguration ML element.

In another embodiment, AP Channel Report elements may be included within an ML element included in the frame, such as within a Basic ML element or a Reconfiguration ML element. The AP Channel Report elements are carried in the STA Profile of only one Per-STA Profile subelement within the ML element (e.g., the first Per-STA Profile subelement) and are not repeated across multiple Per-STA Profile subelements. This restriction reflects that AP Channel Report information is ESS-wide rather than per-link specific. The AP Channel Report elements may be placed at any position within the corresponding frame, consistent with the ordering of other elements and fields included in that frame.

### SMD Roaming as a Trigger for Updated Complete ESS Channel Information

When a non-AP MLD performs SMD roaming to a target AP MLD, the target AP MLD provides, as part of the seamless transition (ST) preparation response, Per-STA Profile information for all accepted links at the target AP MLD to the non-AP MLD. If the AP Channel Report elements provided to the non-AP MLD at the time of initial association have not changed, there is no need to include AP Channel Report elements again in the ST preparation response frame. However, when the set of primary channels used by all APs in the ESS may have changed since initial association, the SMD roaming event may be used as a trigger to deliver the updated primary channel information to the non-AP MLD.

In this case, the ST preparation response frame (e.g., a UHR Link Reconfiguration Response frame) may include one or more AP Channel Report elements conveying the updated set of primary channels used by all APs in the ESS. Similarly, if the set of primary channels has been updated, one or more AP Channel Report elements may additionally be provided in the ST execution response frame. In one embodiment, if the Bounded ESS field is set to a first value (e.g., 1), AP Channel Report elements are always included in the ST preparation response frame and/or the ST execution response frame, regardless of whether the channel information has changed since association. If the Bounded ESS field is set to a second value (e.g., 0), AP Channel Report elements are not included in those frames.

### Neighboring AP Probe Response Frame

When a non-AP MLD requests probe response content for a neighboring AP MLD from its current AP MLD by transmitting a Neighboring AP Probe Request frame, the neighboring AP MLD may include updated AP Channel Report elements in the Neighboring AP Probe Response frame it returns if the primary channels used by all APs in the ESS have been updated since the non-AP MLD’s initial association. The Neighboring AP Probe Response frame is thereby extended to carry one or more AP Channel Report elements providing the latest set of primary channels used by all APs in the ESS, enabling a non-AP MLD to obtain updated complete ESS channel information at the time it probes a neighboring AP MLD. In some embodiments, if the Bounded ESS field is set to a first value (e.g., 1), AP Channel Report elements are always included in the Neighboring AP Probe Response frame. If the Bounded ESS field is set to a second value (e.g., 0), AP Channel Report elements are not included in the Neighboring AP Probe Response frame.

### Method

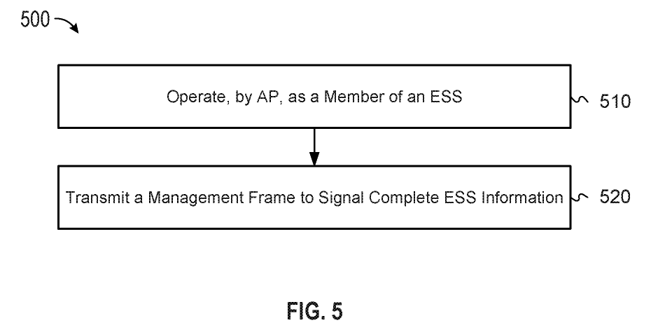

FIG. 5 is a flow diagram illustrating a method 500 for signaling complete ESS channel information. At stage 510, an AP operates as a member of an ESS. The ESS comprises a plurality of APs sharing a common SSID and connected to a common distribution system, such as a wired local area network. Any number of the plurality of APs can form the ESS.

At stage 520, the AP transmits a management frame to a client device. The management frame comprises an indicator set to indicate that complete ESS channel information is provided and one or more elements comprising the complete ESS channel information. The complete ESS channel information comprises primary channel information for the plurality of APs of the ESS. In some embodiments, the ESS consists of the AP only. In such cases, the management frame comprises the indicator set to indicate that complete ESS channel information is provided but includes no element comprising the complete ESS channel information, thereby indicating to the client device that the ESS consists of the AP only.

In various embodiments, the indicator is any one of: a field within a NR element, a bit in a basic multi-link element, a bit in UHR element (such as a UHR Capabilities element or a UHR Operation element), or a field in an ESS report element. In one embodiment, the indicator is a bounded ESS field carried in a UHR capabilities element.

In one embodiment, the management frame is a (Re)Association Response frame, and the one or more elements comprise any one of: one or more NR elements, one or more RNR elements, or one or more AP channel report elements. In another embodiment, the management frame is any one of: a probe response frame, a BTM request frame, a Neighbor Report Response frame, or a (Re)Association Response frame, the one or more elements comprise one or more NR elements, and the indicator is a field of the one or more NR elements.

In another embodiment, the second management frame is a UHR link reconfiguration response frame e.g. sent as a response for SMD roaming preparation or SMD roaming execution, and the UHR link reconfiguration response frame comprises one or more AP channel report elements carrying the updated complete ESS channel information. In yet another embodiment, the second management frame is a UHR Neighboring AP Probe Response frame sent in response to a UHR Neighboring AP Probe Request frame received from the client, and the UHR Neighboring AP Probe Response frame comprises one or more AP channel report elements carrying the updated complete ESS channel information.

In one embodiment, the AP further transmits a second management frame to the client device when there is a change to the complete ESS channel information. The second management frame is an unsolicited BTM request or an unsolicited neighbor report response frame and comprises updated complete ESS channel information reflecting the change. In another embodiment, the second management frame is a UHR link reconfiguration notify frame, and the UHR link reconfiguration notify frame comprises one or more AP channel report elements carrying the updated complete ESS channel information.

In one embodiment, the AP further transmits a second management frame to the client device when there is a change to the complete ESS channel information, wherein the change comprises the ESS consisting of the AP only. In such embodiments, the second management frame comprises the indicator and no elements comprising the complete ESS channel information to indicate the ESS consists of the AP only.

In one embodiment, the AP is part of a SMD, and the management frame further comprises an SMD indicator set to indicate the management frame comprises complete information for the SMD. In another embodiment, in response to a second client device performing SMD roaming to the AP, the AP transmits a ST preparation response frame or an ST execution response frame comprising updated complete ESS channel information.

### Systems

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing signaling of complete ESS channel information. Computing device 600, for example, may provide an operating environment for the controller 105, the APs, the client devices, the SMD-ME 205, and the like. The controller 105, the APs, the client devices, the SMD-ME 205, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the controller 105, the APs, the client devices, the SMD-ME 205, etc. In various implementations, the communications device 700 may comprise a logic circuit. The logic circuit may include physical circuits to perform operations described for one or more of the controller 105, the APs, the client devices, the SMD-ME 205, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the controller 105, the APs, the client devices, the SMD-ME 205, etc., storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY layer processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
operating, by an access point (AP), as a member of an extended service set (ESS), the ESS comprising a plurality of APs sharing a common service set identifier (SSID) and connected to a common distribution system; and
transmitting, by the AP, a management frame to a client device, the management frame comprising:
an indicator set to indicate that complete ESS channel information is provided, and
one or more elements comprising the complete ESS channel information, wherein the complete ESS channel information comprises primary channel information for the plurality of APs of the ESS.

2. The method of claim 1, wherein the indicator is any one of: a field within a neighbor report (NR) element, a bit in a basic multi-link element, a bit in an ultra high reliability (UHR) element, or a field in an ESS report element.

3. The method of claim 1, wherein the indicator is a bounded ESS field carried in a UHR capabilities element.

4. The method of claim 1, wherein:
the management frame is a (re)association response frame; and
the one or more elements comprise any one of: one or more NR elements, one or more reduced neighbor report (RNR) elements, or one or more AP channel report elements.

5. The method of claim 1, wherein:
the management frame is any one of: a probe response frame, a basic service set transition management (BTM) request frame, a neighbor report response frame, or a (re)association response frame;
the one or more elements comprise one or more NR elements; and
the indicator is a field of the one or more NR elements.

6. The method of claim 1, further comprising:
transmitting a second management frame to the client device when there is a change to the complete ESS channel information, wherein:
the management frame is an unsolicited BTM request or an unsolicited neighbor report response frame; and
the management frame comprises updated complete ESS channel information reflecting the change.

7. The method of claim 6, wherein:
the second management frame is a UHR link reconfiguration notify frame; and
the UHR link reconfiguration notify frame comprises one or more AP channel report elements carrying the updated complete ESS channel information.

8. The method of claim 1, further comprising:
transmitting a second management frame to the client device when there is a change to the complete ESS channel information, wherein:
the change comprises the ESS consisting of the AP only; and
the management frame comprises the indicator and no elements comprising the complete ESS channel information to indicate the ESS consists of the AP only.

9. The method of claim 1, wherein:
the AP is part of a seamless mobility domain (SMD); and
the management frame further comprises an SMD indicator set to indicate the management frame comprises complete information for the SMD.

10. The method of claim 1, further comprising:
in response to a second client device performing SMD roaming to the AP, transmitting a seamless transition (ST) preparation response frame or an ST execution response frame comprising updated complete ESS channel information.

11. The method of claim 1, further comprising:
in response to the client device requesting a neighboring AP probe response information from the AP, transmitting a neighboring AP probe response frame comprising updated complete ESS channel information.

12. A system comprising:
a memory storage; and
a processing unit coupled to the memory storage, wherein the processing unit is operative to:
operate as an access point (AP) that is a member of an extended service set (ESS), the ESS comprising a plurality of APs sharing a common service set identifier (SSID) and connected to a common distribution system; and
transmit a management frame to a client device, the management frame comprising:
an indicator set to indicate that complete ESS channel information is provided, and
one or more elements comprising the complete ESS channel information, wherein the complete ESS channel information comprises primary channel information for the plurality of APs of the ESS.

13. The system of claim 12, wherein:
the management frame is a (re)association response frame; and
the one or more elements comprise any one of: one or more NR elements, one or more reduced neighbor report (RNR) elements, or one or more AP channel report elements.

14. The system of claim 12, wherein:
the management frame is any one of: a probe response frame, a basic service set transition management (BTM) request frame, a neighbor report response frame, or a (re)association response frame;
the one or more elements comprise one or more NR elements; and
the indicator is a field of the one or more NR elements.

15. The system of claim 12, wherein the processing unit is further operative to:
transmit a second management frame to the client device when there is a change to the complete ESS channel information, wherein:
the management frame is an unsolicited BTM request or an unsolicited neighbor report response frame; and
the management frame comprises updated complete ESS channel information reflecting the change.

16. The system of claim 12, wherein the indicator is any one of: a bounded ESS field in an ultra high reliability (UHR) capabilities element, a bit in a basic multi-link element, a bit in a UHR element, or a field in an ESS report element.

17. A method comprising:
operating, by an access point (AP), as a member of an extended service set (ESS), the ESS consisting of the AP; and
transmitting, by the AP, a management frame to a client device, the management frame comprising:
an indicator set to indicate that complete ESS channel information is provided, and
no elements comprising the complete ESS channel information to indicate the ESS consists of the AP only.

18. The method of claim 17, wherein the indicator is any one of: a bounded ESS field in an ultra high reliability (UHR) capabilities element, a bit in a basic multi-link element, a bit in a UHR element, or a field in an ESS report element.

19. The method of claim 17, wherein the management frame is any one of a (re)association response frame, a probe response frame, a neighbor report response frame, a beacon frame, or a basic service set transition management (BTM) request frame.

20. The method of claim 17, further comprising:
transmitting a second management frame to the client device when there is a change to the complete ESS channel information, wherein:
the change comprises the ESS comprising a plurality of APs sharing a common service set identifier (SSID) and connected to a common distribution system; and
the management frame comprises the indicator and one or more elements comprising updated complete ESS channel information, wherein the updated complete
ESS channel information comprises primary channel information for the plurality of APs of the ESS.
